(19) United States
(12) Patent Application Publication
(10) Pub. No.: US 2011/0293446 A1
(43) Pub. Date: Dec. 1, 2011

(54) COOLANT COMPRESSOR WITH EVAPORATOR SHELL

(75) Inventors: Axel Stupnik, Graz (AT); Hans-Peter Schoegler, Fehring (AT)

(73) Assignee: ACC Austria GmbH, Fuerstenfeld (AT)

(21) Appl. No.: 12/998,436

(22) PCT Filed: Oct. 19, 2009
(86) PCT No.: PCT/EP2009/063673

§ 371 Date: Jun. 1, 2011

(30) Foreign Application Priority Data
Oct. 21, 2008 (AT) GM 602/2008

(51) Int. Cl. F04B 39/00; B23P 15/00

(52) U.S. Cl. 417/363; 29/888.02

(57) ABSTRACT

What is shown is a housing of a small coolant compressor comprising an evaporator shell, wherein the evaporator shell is formed at least by a metal wall (2) fastened directly to the housing (1) in sealing fashion, the wall following a perimeter line of the housing (1) and by at least one partial surface (1a) of the housing disposed inside the wall (2). At least one damping element (5) for damping the oscillations transferred from the housing (1) to the wall (2) is fastened to the wall (2) at a distance from the housing (1). In order to reduce noise emissions, one or more damping elements (5-10) encompass the free upper edge of the wall (2).

### FIELD OF THE INVENTION

The present invention relates to a housing of a small coolant compressor having an evaporator shell, whereby the evaporator shell is formed at least by means of a wall made of metal, attached directly on the housing, in leak-proof manner, following a circumference line of the housing, and at least a partial surface of the housing that lies within the wall, and whereby at least one damping element for damping the vibrations transferred from the housing to the wall is attached to the wall, at a distance from the housing, in accordance with the preamble of claim 1, as well as to a method for equipping an evaporator shell of a housing of a small coolant compressor, having a wall, with at least one damping element disposed on the wall, in accordance with the preamble of claims 17 and 18.

### STATE OF THE ART

Small coolant compressors are predominantly used in the household sector. They are generally disposed on the back of a refrigerator and connected to the latter, and serve for compression of a circulating coolant, thereby transporting heat away from the cooling space of the refrigerator, and giving it off to the surroundings.

The coolant compressor, which comprises a hermetically sealed compressor housing, has an electric motor that drives a piston that oscillates in a cylinder for compression of the coolant, by way of a crankshaft. In this connection, the compressor housing consists of a lid part and a base part, whereby feed lines and discharge lines are provided, which lead into the compressor housing and out of it, in order to convey the coolant to the cylinder and from it back into the coolant circuit.

During operation of a cooling appliance, condensed liquid occurs, particularly due to humidity that occurs locally and is condensed at low temperatures, and this liquid must be collected in a collection container provided specifically for this purpose. These collection containers either have to be emptied on a regular basis, or they guarantee sufficient evaporation, on the basis of a suitable design and placement, so that condensed fluid is converted back into the gaseous state and can escape from the area of the small refrigeration machine.

It is practical if the collection container is disposed close to the compressor housing of the coolant compressor, since the latter represents a heat source and promotes evaporation of the collected liquid. Collection containers are known from the state of the art, for example from AT 7.706 U1, where metallic delimitation walls are provided, among other things, which enclose the compressor housing, in leak-proof manner, along a circumference line of the compressor housing, and form a container that is open toward the top. In this connection, the delimitation walls are either structured in one piece with a housing part, or attached to the housing by means of adhesive, screws, weld connections, flange connections, or the like. It only has to be ensured that the contact region between delimitation wall and housing is leak-proof, so that the condensed liquid collected within the delimitation wall remains in the evaporator shell formed by delimitation wall and housing. By means of such a design, the heat that is given off by way of the compressor housing can be used in almost direct manner to evaporate the condensed liquid.

Direct attachment of the metallic delimitation wall to the metallic housing (in other words in the case of a one-piece configuration with a housing part, in the case of a screw, weld, or flange connection) has the disadvantage that the vibrations of the compressor are transferred to the housing and furthermore to the delimitation wall, so that the metallic evaporator shell now in turn further increases the noise emission of the compressor, because of its open structure and its relatively large surface area.

It is therefore a task of the present invention to reduce the noise emission of the compressor by way of the evaporator shell. This is generally possibly by means of a change in the structural rigidity or by means of damping.

A possible solution would be to increase the rigidity of the metallic evaporator shell. However, this would require additional reinforcements or ribs that cannot be produced, in a deep-drawing process, without greater effort, or have such a disadvantageous influence on the construction size of the evaporator shell that a lot of construction space is required for little holding volume.

A different solution is proposed by U.S. Pat. No. 5,699,677 A1, in which the wall of the evaporator shell is attached to the compressor housing by means of a polyurethane adhesive layer. The elastic properties of the adhesive layer are selected in such a manner that vibrations transferred by the compressor are damped.

However, in the case of this solution, it is necessary to do without the direct connection between compressor housing made of metal and delimitation wall made of metal.

A cooling appliance compressor is already known from WO 2008/092223 A2, whose evaporator shell is provided with damping elements for the purpose of reducing the vibrations that proceed from the compressor housing. In this connection, the damping elements are disposed laterally on the evaporator shell. The walls of the evaporator shell are structured to be hollow, so that chambers or tube-shaped damping elements are formed. As compared with this embodiment, a structure and a placement of damping elements of the stated type, which are more advantageous in terms of production technology and vibration damping technology, is aimed at.

It is particularly a task of the invention to further reduce the noise emissions of the compressor by way of the evaporator shell.

### PRESENTATION OF THE INVENTION

According to the invention, this task is accomplished by means of the characterizing features of claim 1. In order to damp the high vibration amplitude at the free upper edge of the wall, it is provided that the at least one damping element encloses the free upper edge of the wall. In particular, it can be provided that all the damping elements are attached to the free edge of the wall.

It is ensured, by means of attaching one or more damping elements to the upper edge of the wall, that the wall itself, which can easily be excited to vibrate because of the free upper edge, is damped. The damping elements bring about the result that at least a part of the vibration energy is converted to heat.

According to a preferred embodiment variant of the invention, the at least one damping element is set onto the free upper edge of the wall.

According to a particularly preferred embodiment variant of the invention, the at least one damping element has a groove whose width essentially corresponds to the thickness of the wall, and the damping element is set onto the upper edge of the wall by means of this groove.

Various possibilities are available for selection with regard to the material of the damping element. One embodiment consists in that one or more damping elements consist of metal. Metallic damping elements help to locally change the resonance frequency of the wall, on the basis of their mass, so that the entire wall can no longer be put into resonance.

A particular embodiment of the metallic damping element consists in that the damping element is formed in one piece with the wall, particularly by means of bending the upper edge of the wall. By bending the upper edge of the wall, this upper edge is reinforced, and vibrations are thereby damped.

Another embodiment consists in that one or more damping elements consist of plastic. The term plastic comprises plastomers (thermoplastics), duromers, and elastomers. Because of their elasticity, they are deformed by the vibrations, and this costs vibration energy, which is therefore no longer available for vibrations of the wall.

Another possibility is the use of composite materials that have a multi-layer structure, whereby the individual layers of the composite material particularly consist of elastomers and/or plastomers and/or duromers and/or metals and/or woods. For example, elastic layers (elastomer) can be used in combination with layers that consist of heavier materials (metal foil).

At least one damping element can be attached in such a manner that it exerts a bias force on the wall. If the wall is then excited to vibrate, every movement must take place counter to this bias force. Thus, a damping element can be placed around the wall, in leak-proof manner, for example.

The following possibilities exist in terms of the type of attachment: one or more damping elements can be attached to the wall with shape fit and/or force fit and/or material fit. The shape-fit attachment has the advantage that the damping elements can be attached to the wall without further attachment means. The force-fit attachment ensures a good transfer of the vibration energy from the wall to the damping element.

If it is provided that at least one damping element is releasably attached to the wall, then these damping elements can be replaced in particularly simple manner, but also, additional damping elements can easily be attached, or damping elements that are not needed can be removed.

The alternative, namely that at least one damping element is attached to the wall in non-releasable manner, has the advantage that these elements permanently remain in place during longer operating times of the compressor.

Of course, combinations of damping elements affixed in releasable and non-releasable manner are also possible. Thus, one or more metallic damping elements could be welded onto the wall, while other damping elements made of rubber are simply set onto the free (upper) edge of the wall, with shape fit.

An essentially linear attachment is a good possibility if a heavy metallic element, for example, is to be attached in simple manner. Examples of linear attachments are found in FIG. 7-10.

An essentially planar attachment of the damping element is practical if the damping element has a planar shape and is supposed to be well connected with the wall at all points. An example of a planar attachment is found in FIG. 6. Such an element can be glued on, for example.

In order to achieve uniform damping over the entire circumference of the wall, it can be provided that a damping element is disposed along the entire circumference of the wall.

A particularly leak-proof and permanent structure of the evaporator shell according to the invention can be achieved in that the wall of the evaporator shell is welded onto the housing.

According to another embodiment of the invention, the cross-section of at least one of the damping elements can vary along the circumference of the wall.

Claim 17 relates to a method for equipping an evaporator shell of a housing of a small coolant compressor having a wall, according to claim 1, with at least one damping element for damping the vibrations transferred from the housing to the wall, disposed on the wall, whereby it is provided, according to the invention, that the at least one damping element is applied to the free upper edge of the wall, enclosing it, by means of extrusion of a polymer material. The production costs can be clearly lowered in that the damping elements are extruded directly onto the free upper edge of the wall.

As is proposed in a process technology alternative according to claim 18, it is also possible that the free upper edge of the wall is provided, at least in sections, with adhesive, whose mass forms one or more damping elements that enclose the free upper edge of the wall. In this manner, as well, rapid and cost-advantageous production of a damping measure according to the invention is made possible. Experiments have shown that application of relatively small amounts of adhesive in the region of the free upper edge of the wall already leads to satisfactory vibration damping.

### BRIEF DESCRIPTION OF THE FIGURES

Below, a detailed description of the invention, using figures, will be presented. In this connection, the figures show:

FIG. 1 a perspective representation of a housing having an evaporator shell for condensed liquid, according to the state of the art

FIG. 2 a perspective representation of a housing according to the invention, having a circumferential damping element

FIG. 3 a vertical section through the housing from FIG. 2

FIG. 4 a detail from FIG. 3 with damping element

FIG. 5 a detail from FIG. 3 with alternative damping element

FIG. 6 a perspective representation of a housing according to the invention having lateral damping elements

FIG. 7 a perspective representation of a housing according to the invention having a damping element at the edge of the wall

FIG. 8 a perspective representation of a housing according to the invention having two damping elements at the edge of the wall

FIG. 9 a perspective representation of a housing according to the invention having three damping elements at the edge of the wall

FIG. 10 a perspective representation of a housing according to the invention having four damping elements at the edge of the wall

FIG. 11 a diagram that shows the emitted noise of a housing according to the invention in comparison with housings according to the state of the art

### WAYS OF IMPLEMENTING THE INVENTION

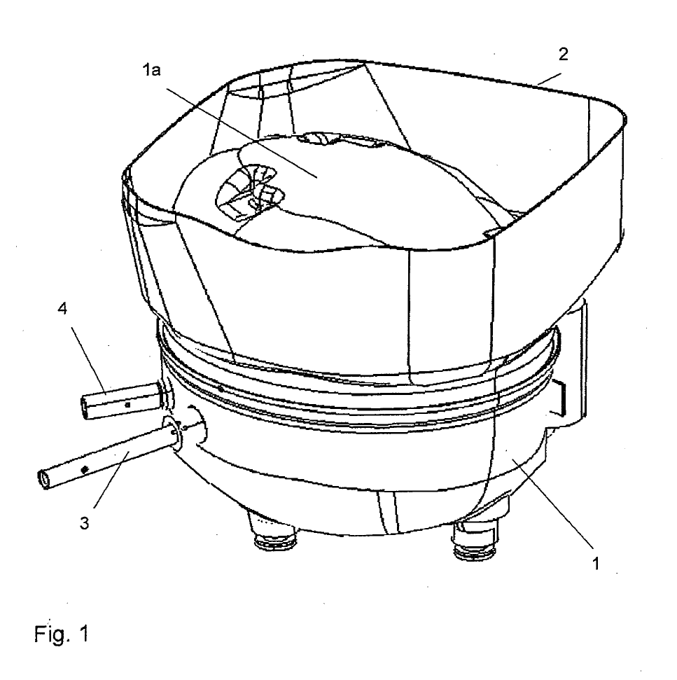

FIG. 1 shows a perspective representation of a housing of a compressor having an evaporator shell for condensed liquid, according to the state of the art. On the housing 1, which has a feed line 3 and a discharge line 4 for coolant for the compressor situated in the housing, a wall 2 made of metal, for example of sheet steel, is welded on, which follows a circumference line of the housing 1. This wall 2 forms the wall of the evaporator shell. The partial surface 1a of the housing that lies within the wall 2 forms the bottom of the evaporator shell.

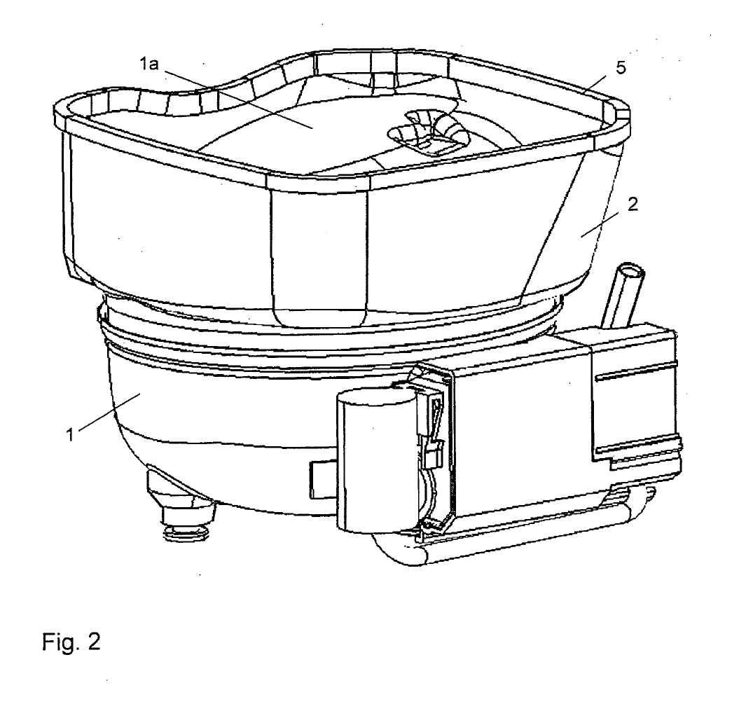

In FIG. 2, the same housing as in FIG. 1 is shown, but now with a possible embodiment of the invention: a circumferential damping element 5 that covers the entire circumference of the edge, attached to the upper edge of the wall 2. The damping element 5 is made of an elastomer, for example of rubber.

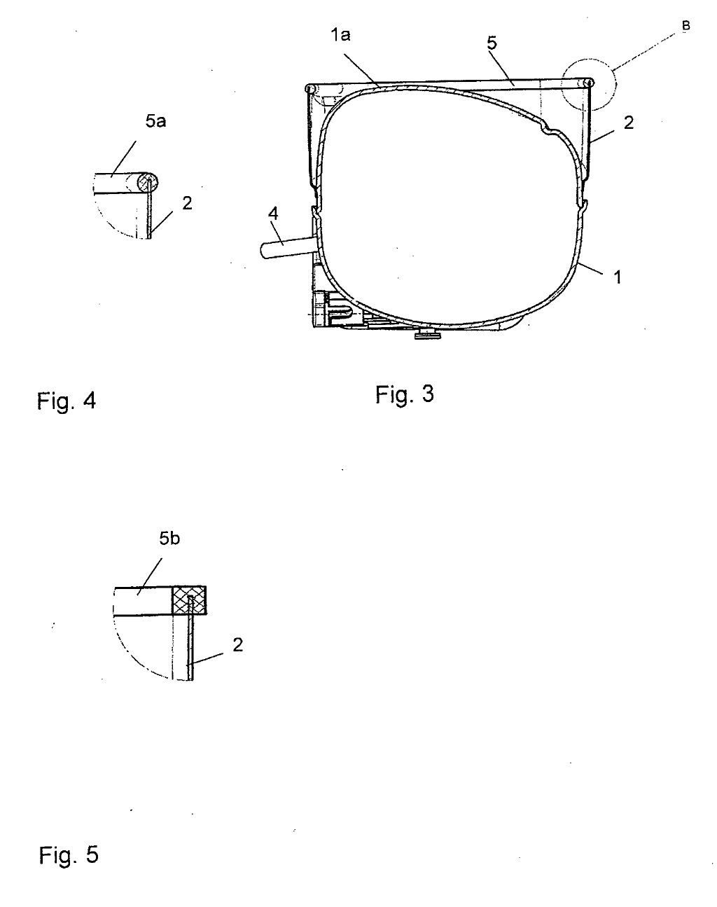

In FIG. 3, a vertical section through the center of the housing 1 from FIG. 2 is shown. On order to be able to better recognize the cross-section of the circumferential damping element 5, the detail on the right upper edge designated with “B” is shown enlarged in FIG. 4.

In FIG. 4, the circumferential damping element 5a set onto the wall 2 is shown in cross-section. It has a circular cross-section and a radial groove that reaches up to about 0.7 diameter into the damping element 5. The groove corresponds to the thickness of the wall 2 in terms of its width, so that shape-fit contact with the wall 2 is made possible. The sealing element 5a is set onto the upper edge of the wall 2 by means of this groove.

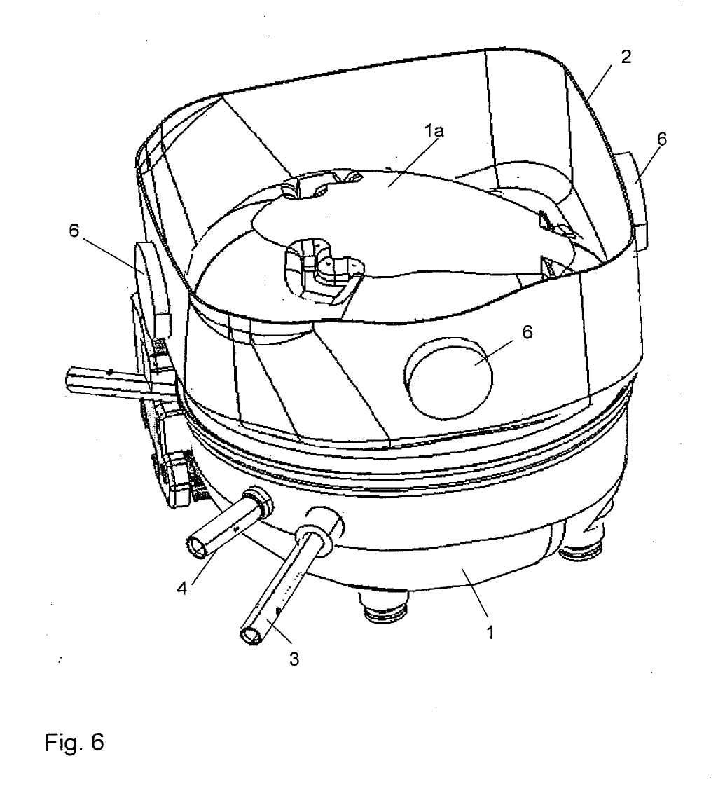

However, other cross-sections of the circumferential damping element 5 are also possible, for example, as shown in FIG. 5, a circumferential damping element having a rectangular cross-section 5b. The groove is disposed to lie normal to the side surface of the rectangular cross-section, it also has a depth of about 70% of the cross-section height, and its width is also adapted to the thickness of the wall 2, so that shape-fit contact between damping element 5b and wall 2 is possible. Other cross-sections of the damping element 5, for example triangular cross-sections, are also possible.

According to FIG. 2-5, the circumferential damping element 5, 5a, 5b is disposed on the free edge of the wall 2. However, embodiments are also possible where a circumferential damping element is affixed only on the inside or only on the outside of the wall 2, directly following the edge of the wall 2 or below it, or embodiments where circumferential damping elements are disposed both on the inside and on the outside of the wall 2. The inner and the outer damping element can be affixed at the same height or different heights.

The circumferential damping element can be attached under bias, but it can also be attached without bias. If the damping element is affixed on the inside or on the outside of the wall 2, the bias can be directed not only inward but also outward.

The circumferential damping element on the inside and/or outside can be configured as a planar rubber band, for example.

Similar effects can also be achieved with multiple non-circumferential but planar damping elements that are distributed over the circumference of the wall 2 and affixed on the inside and/or outside of the wall 2. These can also be mounted with or without bias, as explained above.

FIG. 6 shows a perspective representation of a housing 1 according to the invention, having four lateral damping elements 6 that are affixed to the outside of the wall 2, essentially centered on one of the four wall sections. The four wall sections are formed in that the cross-section of the wall 2 is not circular, but approximately in square shape.

It would also be possible to affix all the damping elements 6 to the inside of the wall 2 or alternately on the inside and outside. Of course, more than four damping elements can also be used.

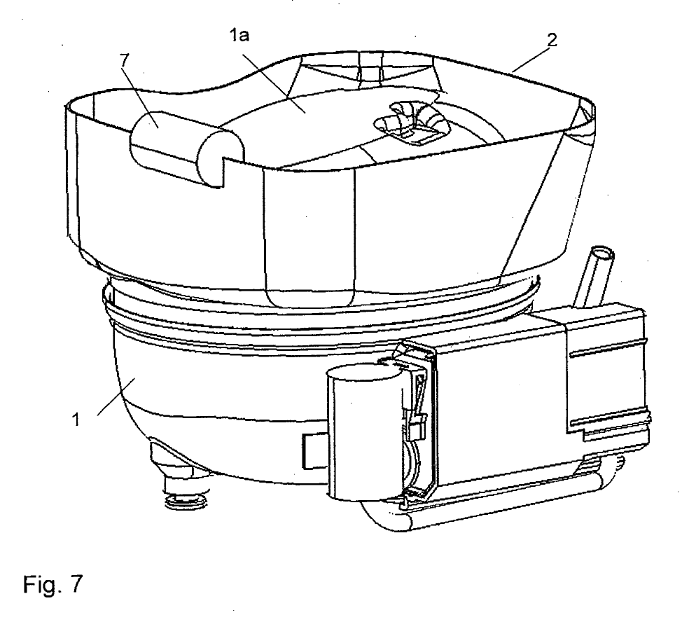

In FIG. 7, a single damping element 7 is mounted on the wall 2. The damping element 7 shown has the shape of a full cylinder, which has a groove that reaches to the middle of the cylinder, in the radial direction. However, the use of a profile as shown in FIG. 3-5 would also be possible, whereby the damping effect is restricted only to the region of the wall 2 to which the damping element is affixed.

The shape of the groove is dimensioned in such a manner that the damping element 7 can be set onto the upper edge of the wall 2 with shape fit. The damping element 7 can be attached to the wall with shape fit and/or force fit and/or material fit. Metal, plastic, or composite materials are possible materials for the damping element 7.

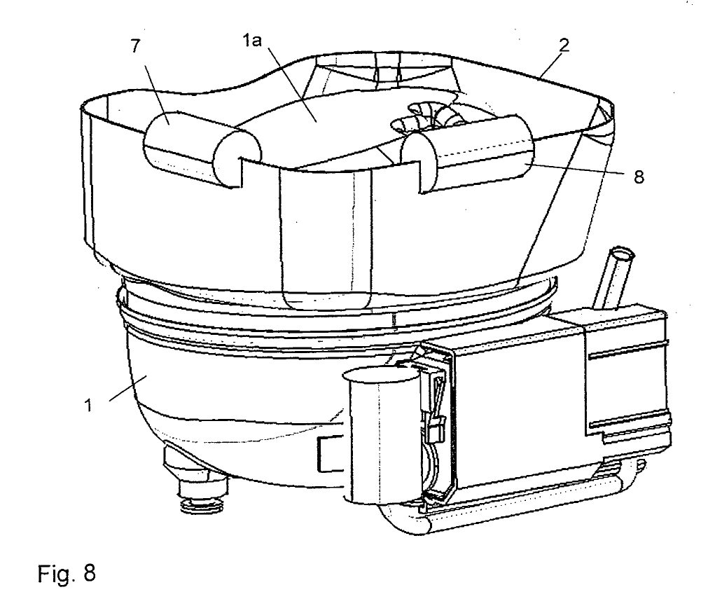

In FIG. 8, an additional, in other words a second damping element 8 is added to the arrangement from FIG. 7. The second damping element 8 shown also has the shape of a full cylinder, which has a groove that reaches to the center of the cylinder, in the radial direction. Again, as explained under FIG. 7, other shapes are possible.

Again, the shape of the groove is dimensioned in such a manner that the damping element 8 can be set onto the upper edge of the wall 2.

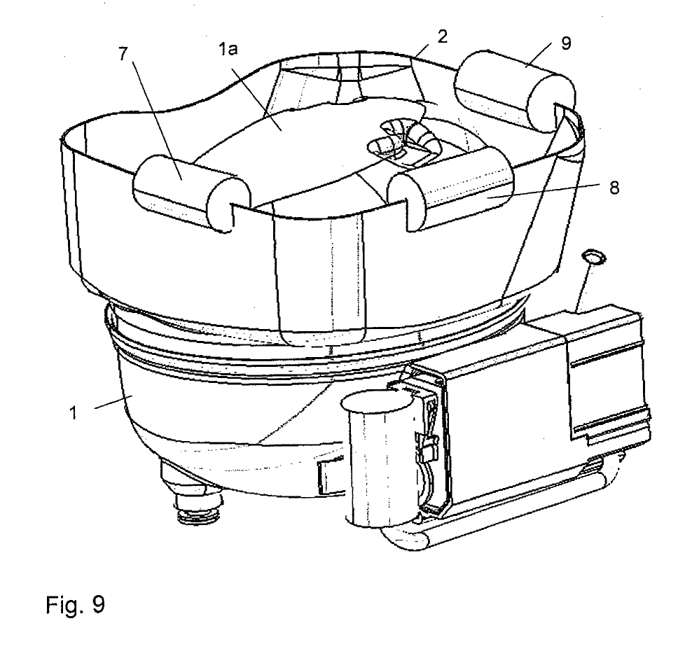

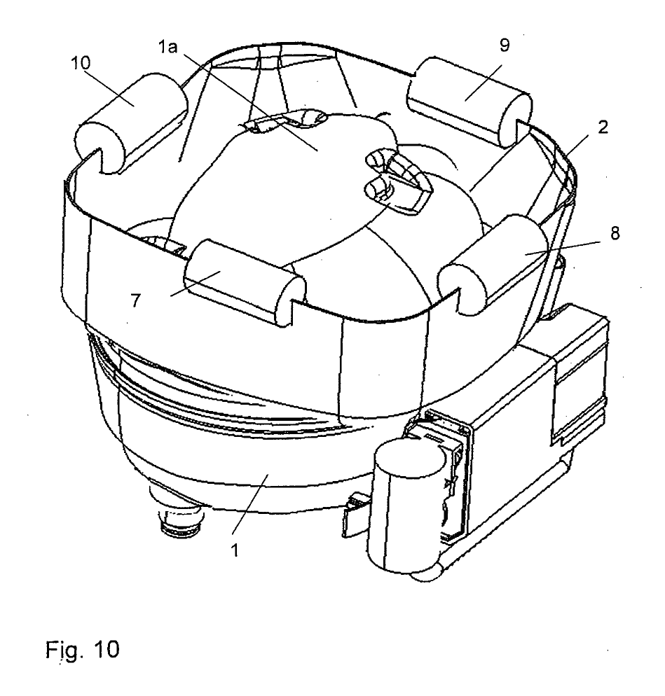

Likewise, additional damping elements 9, 10 can also be added, as shown in FIG. 9 and FIG. 10.

Dimensions and material of the damping elements 7-10 can vary among the individual damping elements 7-10, and can thus be better adapted to the requirements.

Attachment of the damping elements can take place in the most varied ways (with force fit, shape fit and/or material fit).

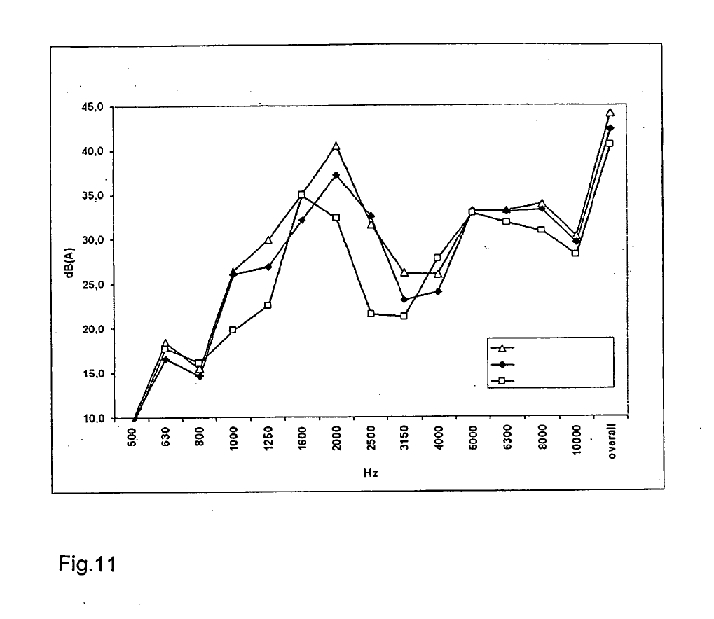

FIG. 11 shows a diagram in which the noise emitted by a compressor housing was measured. The third-octave spectrum is shown.

The emitted noise is plotted on the vertical axis in dB(A).

The frequencies in Hz are plotted on the horizontal axis, the last value on the right side (indicated with “S”) represents the sum level, specifically for three different variants:
housing without damping element (measurement values shown as empty triangles),
housing having a single damping element 7, as in FIG. 7 (measurement values shown as filled diamonds),
housing having a damping element 5 configured as a circumferential ring, as in FIG. 2 (measurement values shown as empty squares).

It is clearly evident that the sum level of the housing having damping elements according to the invention is lower than without damping elements, whereby a solution according to FIG. 2, with a circumferential damping element, brings about greater damping than the solution according to FIG. 7, having a single cylindrical damping element 7.

In accordance with a method that is advantageous in terms of production technology, the at least one damping element 5-10 is applied to the free upper edge of the wall 2, enclosing it, by means of extrusion of a polymer material. Fundamentally, all materials capable of adhesion are suitable for being applied directly to the region of the free upper edge of the wall 2.

It is also possible that the free upper edge of the wall 2 is provided, at least in certain sections, with adhesive whose mass forms one or more damping elements 5-10. The adhesive application in the region of the free upper edge of the wall 2 can take place by means of any desired application methods, for example by means of brushing, spraying, dipping, etc.

Enclosing the free upper edge of the wall 2 can mean enclosing it on one side, i.e. the damping element 5-10 contacting or overlapping an abutment surface that faces upward and either an inside or an outside of the wall 2, or also enclosing it on both sides, i.e. contacting or overlapping the abutment surface that faces upward and both an inside and an outside of the wall 2.

### REFERENCE SYMBOL LIST

1 housing of the compressor
1a bottom of the evaporator shell
2 wall of the evaporator shell
3 feed line
4 discharge line
5 circumferential sealing element
5a circumferential sealing element with a round cross-section
5b circumferential sealing element with a rectangular cross-section
6 lateral damping element
7 first damping element at the edge of the wall 2
8 second damping element at the edge of the wall 2
9 third damping element at the edge of the wall 2
10 fourth damping element at the edge of the wall 2

1. Housing of a small coolant compressor having an evaporator shell, whereby the evaporator shell is formed at least by means of a wall (2) made of metal, attached directly on the housing (1), in leak-proof manner, following a circumference line of the housing (1), and at least a partial surface (1a) of the housing (1) that lies within the wall (2), and whereby at least one damping element (5-10) for damping the vibrations transferred from the housing (1) to the wall (2) is attached to the wall (1), at a distance from the housing (2), wherein the at least one damping element (5-10) encloses the free upper edge of the wall (2).

2. Housing with evaporator shell according to claim 1, wherein the at least one damping element (5-10) is set onto the free upper edge of the wall (2).

3. Housing with evaporator shell according to claim 1, wherein the at least one damping element (5-10) has a groove whose width essentially corresponds to the thickness of the wall (2), and the damping element (5-10) is set onto the upper edge of the wall (2) by means of this groove.

4. Housing with evaporator shell according to claim 1, wherein one or more damping elements (6-10) consist of metal.

5. Housing with evaporator shell according to claim 4, wherein the damping element is formed in one piece with the wall (2), particularly formed by means of bending the upper edge of the wall (2).

6. Housing with evaporator shell according to claim 1, wherein one or more damping elements (5, 5a, 5b) consist of plastic (elastomer, plastomer, duromer).

7. Housing with evaporator shell according to claim 1, wherein one or more damping elements consist of composite materials that have a multi-layer structure, whereby the individual layers of the composite material particularly consist of elastomers and/or plastomers and/or duromers and/or metals and/or woods.

8. Housing with evaporator shell according to claim 6, wherein at least one damping element (5, 5a, 5b) is attached in such a manner that it exerts a bias force on the wall (2).

9. Housing with evaporator shell according to claim 1, wherein one or more damping elements (5-10) is/are attached to the wall (2) with shape fit and/or force fit and/or material fit.

10. Housing with evaporator shell according to claim 1, wherein at least one damping element (5-10) is releasably attached to the wall.

11. Housing with evaporator shell according to claim 1, wherein at least one damping element (5-10) is non-releasably attached to the wall.

12. Housing with evaporator shell according to claim 1, wherein at least one damping element has an essentially linear attachment.

13. Housing with evaporator shell according to claim 1, wherein at least one damping element (5-10) has an essentially planar attachment.

14. Housing with evaporator shell according to claim 1, wherein a damping element (5, 5a, 5b) is disposed along the entire circumference of the wall (2).

15. Housing with evaporator shell according to claim 1, wherein the wall (2) is welded onto the housing (1).

16. Housing with evaporator shell according to claim 1, wherein the cross-section of at least one of the damping elements (5-10) varies along the circumference of the wall (2).

17. Method for equipping an evaporator shell of a housing (1) of a small coolant compressor having a wall (2), according to claim 1, with at least one damping element (5-10) for damping the vibrations transferred from the housing (1) to the wall (2), disposed on the wall (2), wherein the at least one damping element (5-10) is applied to the free upper edge of the wall (2), enclosing it, by means of extrusion of a polymer material.

18. Method for equipping an evaporator shell of a housing (1) of a small coolant compressor having a wall (2), according to claim 1, with at least one damping element (5-10) for damping the vibrations transferred from the housing (1) to the wall (2) disposed on the wall (2), wherein the free upper edge of the wall (2) is provided, at least in sections, with adhesive, whose mass forms one or more damping elements (5-10) that enclose the free upper edge of the wall (2).
